(19) United States
(12) Patent Application Publication
(10) Pub. No.: US 2020/0046091 A1
(43) Pub. Date: Feb. 13, 2020

(54) HANDS-FREE SYSTEM FOR A USER

(71) Applicant: Stéphane DANTIN, Gréoux-les-Bains (FR)

(72) Inventor: Stéphane DANTIN, Gréoux-les-Bains (FR)

(21) Appl. No.: 16/485,535

(22) PCT Filed: Feb. 6, 2018
(86) PCT No.: PCT/FR2018/050297

§ 371 Date: Aug. 13, 2019

(30) Foreign Application Priority Data
Feb. 14, 2017 (FR) 1770137

(51) Int. Cl. A45B 11/02; A45F 3/10; A45C 13/40; G06F 1/16; A45F 3/02

(52) U.S. Cl. CPC A45B 11/02; A45F 3/10; A45F 2005/027; G06F 1/1633; A45F 3/02; A45C 13/40

(57) ABSTRACT

A hands-free system for a user includes a rigid frame and a support fixed to the rigid frame. It is provided that the hands-free system is such that when it is arranged around the user tilts under the effect of a force of gravity of the support frontwards of the user about a rotation axis, and that the hands-free system includes three support points on the user to retain the tilting thereof such that the hands-free system is mounted on the user, two of the three points called front points acting on the iliac bones of the user and the third point called back point acting on the spine of the user.

### TECHNICAL FIELD OF THE INVENTION

The present invention relates to a hands-free system intended for a user and comprising a frame and a support. This is a system which also makes it possible to transport loads.

### STATE OF THE ART

A backpack (2) is known from document GB2350286A, comprising a bag (3), a shoulder strap (6, 7), a support frame 4, 5 and a belt (9). The chassis 4, 5 is fixed to the pocket (3) at a first high point of the adjacent bag and at a second level with back pivot for a wearer. The lower end of the chassis is connected to the hip belt at a third point, for example by means of one or more grips. A load distribution element 20 is connected to the chassis or to the pocket in the vicinity of the second connecting point, and comprises a pair of wing portions (20a) arranged around a central portion (20b) and extending symmetrically downwards and outwards with respect to the bag. There are connecting means for transmitting a flexible load extended between the end of each wing 20a and the hip belt (9) at the fourth and fifth points respectively, which can be at/adjacent to ischium humps of the wearer. The hip belt (9) can be connected flexibly in the bag at/adjacent to the third point. The shoulder strap (6, 7) can be fixed to the chassis or to the pocket. The load distribution element can be separated from or secured to the frame and the wing thereof of the portions 20a and 20b can be formed of one single holding.

The frame can comprise one single longitudinal bar (25) or two bars spaced apart 4 with a crosspiece 5 at the top, or it can comprise a profiled plate (30). Here, it can have a flexible strip 13 between the second and third connecting points.

However, according to this document GB2350286A, a compression force remains applied to the intervertebral discs from the force of gravity which is exerted at the level of the shoulders of the user.

A support for a computer, notepad or other is known from document US20140085814A1, comprising a body support strap which can be placed around the neck or the shoulders of a user, and a unit for reinforcing the body which positions a computer outwards from the torso of the user.

However, according to this document US20140085814A1, it is always provided to hold a computer using a strap around the neck or the shoulders of the user. This strap can impede the movements of the user and even become painful for the cervical vertebrae.

Documents U.S. Pat. Nos. 2,987,231A, 2,995,281A, WO2012/139198A1, US2004/108422A1, U.S. Pat. No. 5,421,499A, US2015/223590, U.S. Pat. No. 3,876,125A, US2007/164987A1, or also FR2958135A1, describe systems for transporting loads, systematically provided with strap, belt, shoulder strap or other fastening which have a support surrounding a portion of the user and which not only impede the movements of the user and cause pain to the cervical vertebrae.

There is therefore a need for a comfortable hands-free system, impeding none of the movements of the user and making it possible to avoid the force of gravity being exerted on the intervertebral discs, in particular the disc L1-L2.

### DISCLOSURE OF THE INVENTION

The invention aims to respond to this desire, while overcoming at least one of these abovementioned disadvantages.

According to the invention, a hands-free system intended for a user and comprising a rigid frame and a support fixed to the rigid frame is proposed.

According to a general feature, the hands-free system is configured such that when it is arranged around the user, it tilts under the effect of a force of gravity of the support frontwards of the user about a rotation axis, and in that the hands-free system comprises, when using, three support points on the user to retain the tilting thereof, such that the hands-free system is mounted on the user, two of said three points called front points, acting when using, on the iliac bones of the user and the third point called back point, acting when using, between the two shoulder blades of the user on their spine, and in that the rigid frame comprises the back point and comprises a first tube which surrounds, when using, one of the two sides of the user by going from the support to the back point, the first tube having the shape of a curve according to which the back point is located at a level above the support.

This invention has the advantage of remaining mounted on the user, only thanks to the support points and this even with heavy loads and this is a surprising effect for a person skilled in the art, who, as can be seen in documents U.S. Pat. Nos. 2,987,231A, 2,995,281A, WO2012/139198A1, US2004/108422A1, U.S. Pat. No. 5,421,499A, US2015/223590, U.S. Pat. No. 3,876,125A, US2007/164987A1, or FR2958135A1, systematically resorts to a strap, belt, shoulder strap or other fastening which has a support surrounding a portion of the user.

Thus, the weight of the support does not rest on the vertebral discs, which reduces stresses, in particular on the disc L1-L2 on which most of the herniated discs are triggered.

In addition, the neck of the user is not urged, to the extent that the comfort is increased in this, and the rotation movements of the neck are easily possible.

The front points are close to the centre of gravity of the user to prevent an imbalance of the user. In addition, the action thereof is carried out at a placement of the body which remains difficult, whatever the corpulence of the user.

The back points acts, for example, on several vertebrae of the user. Thus, stresses on each of the vertebrae on which the back point acts are limited.

Preferably, the back point acts between the two shoulder blades of the user, so as to not impede the movements of the arms of the user.

In addition, it is considered that the back and front points can have a surface for applying force on the user, greater than that of one point. For example, the application surface is 5 cm².

According to other features taken individually or in combination:
the rigid frame comprises a back support attached to the first tube, the back support comprising the back point.
the back support comprises metal.

Thus, a counterweight is obtained at the level of the back support which limits the forces applied by way of the back point on the spine.

Indeed, this weight balances that supported by the front points by making it possible to maintain a balance close to the centre of gravity of the wearer while making it possible for the support force of the back point on the spine to remain comfortable. This makes it possible to avoid an alteration of the posture of the user.
the hands-free system comprises a sliding rod and a counterweight mounted sliding on said sliding rod, the counterweight being placed at the back beyond the rigid frame.

Thus, a counterweight is obtained, which limits the forces applied by way of the back point. In particular, in the case where heavy leads are deposited on the support.

My making the counterweight slide, the force exerted by the counterweight can be adjusted.

Advantageously, the sliding tube is added in the bottom portion in order to conserve, at much as possible, stability of the assembly.
the rigid frame comprises a second tube, surrounding when using, the other side of the user, the sliding rod being fixed to the second tube and the second tube is fixed to the first tube.

Thus, the structure of the rigid frame can be reinforced. It is useful, in particular, to carry very heavy loads.
the force of gravity is applied, when using, on the rigid frame by way of an application point, the application point being located in front of the user such that the rotation axis is arranged between the user and the application point.

In other words, the rotation axis is arranged between the user and the application point, such that the hands-free system tilts frontwards when it is mounted on the user.
a ratio L2/L1 is between 1.2 and 5 wherein L1 is the distance between the rotation axis and the application point and L2 is the distance between the rotation axis and the back point.

By selecting a distance L2 greater than the distance L1, equally the force applied on the spine by the back point is reduced.
the support comprises a tablet fixed on the rigid frame, the tablet comprising two front points.
the rigid frame comprises the two front points.
the support comprises a rod and an annular frame to receive a bucket, the rod being fixed on the rigid frame and the rod is configured to extend along an oblique direction upwards with respect to the horizontal when the hands-free system is mounted on the user.

With the rod extending obliquely, this makes it possible to clear the legs of the user, which is useful, in particular if they work on a ladder or if they move around.
the support comprises a rod and a container to receive a longitudinal element, the rod being fixed on the rigid frame.

For example, the longitudinal element is the mast of a flag, a fishing rod or a pole capable of being connected to a device capable of taking photos or videos.
the support comprises a tray.

It can also be provided that the support comprises other tools or systems, for example a baby carrier, a toolbox, a desk, a case, a crate or a bucket. It could also be provided that the support is capable of supporting musical instruments, keyboards.

### DESCRIPTION OF THE FIGURES

Other features and advantages of the invention will appear upon examining the detailed description of implementations and embodiments, not at all limiting, and the appended drawings, wherein:

FIGS. 1, 2, 3, 4, 5, 6 and 7, represent, according to a first embodiment, views of the hands-free system according to the invention;

FIG. 8 represents the hands-free system according to the first embodiment mounted on the user;

FIGS. 9 and 10 explain the functioning of the hands-free system;

FIG. 11 represents the hands-free system according to a second embodiment of the invention;

FIG. 12 represents the hands-free system according to a third embodiment of the invention;

FIG. 13 represents the hands-free system according to a fourth embodiment of the invention;

FIGS. 14 and 15 represent the hands-free system according to a first variant of a fifth embodiment of the invention; and

FIGS. 16 and 17 represent the hands-free system according to a second variant of the fifth embodiment of the invention.

Identical, similar, or comparable elements have the same reference from one figure to the other.

### DESCRIPTION OF EMBODIMENT EXAMPLES OF THE INVENTION

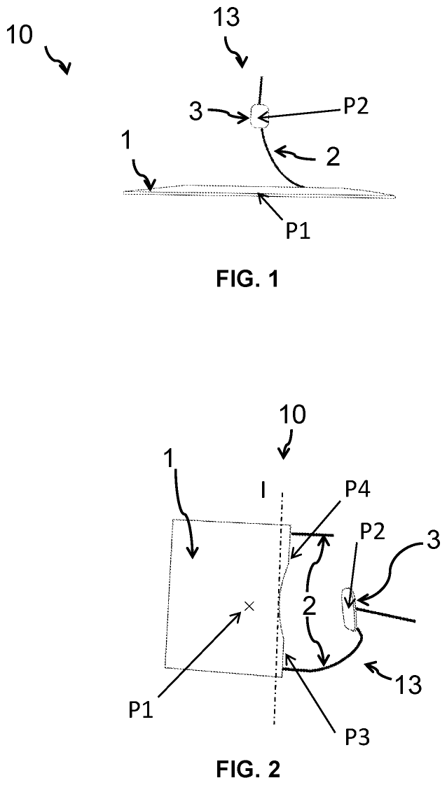

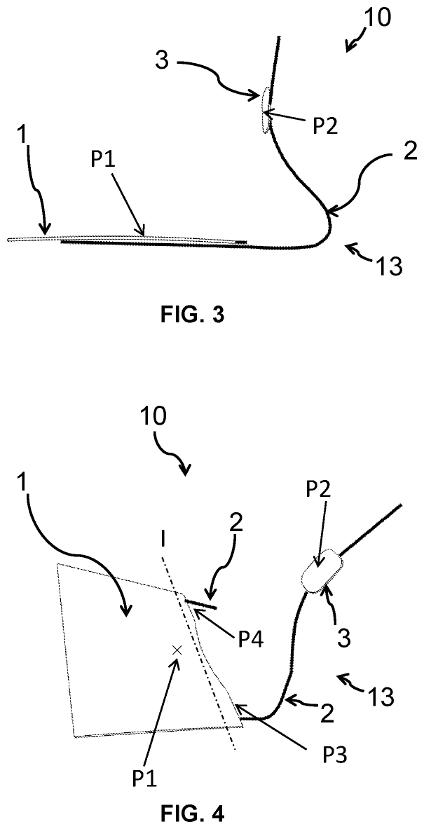

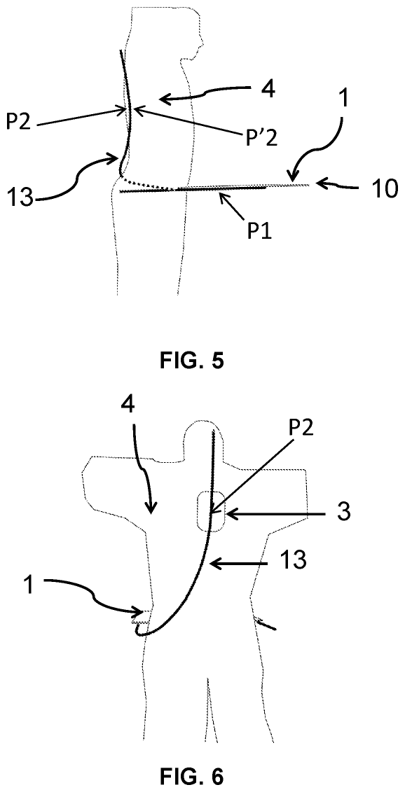

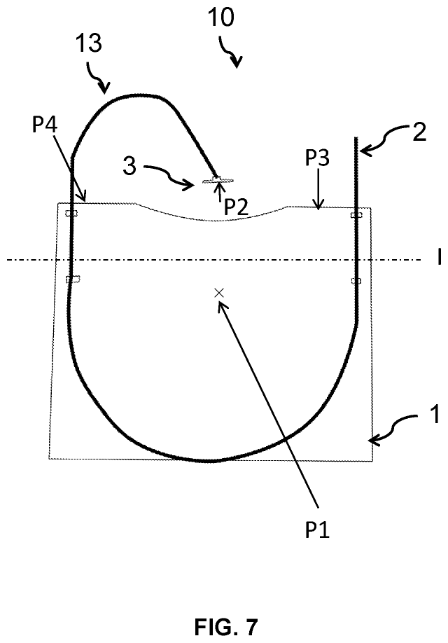

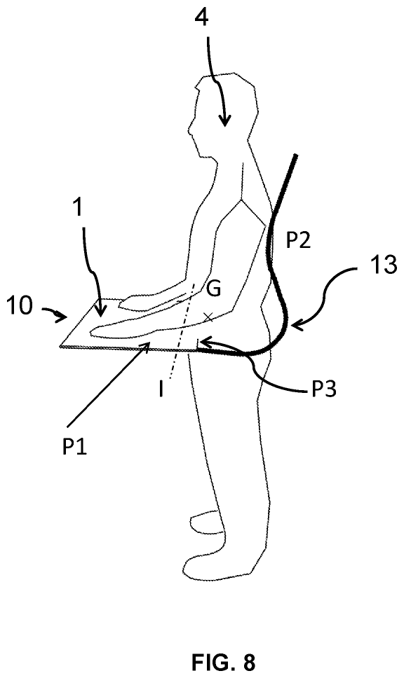

FIGS. 1 to 8 represent, according to a first embodiment, views of the hands-free system according to the invention. More specifically, FIG. 1 corresponds to a front view, FIG. 2 corresponds to a top view, FIG. 3 corresponds to a side view, FIG. 4 corresponds to a three-quarter view, FIG. 5 corresponds to a side view when the hands-free system is mounted on the user, FIG. 6 corresponds to a rear view when the hands-free system is mounted on the user, FIG. 7 corresponds to a bottom view, FIG. 8 corresponds to a side view when the hands-free system is mounted on the user.

The hands-free system 10 intended for a user 4 comprises a rigid frame 13 and a support 1 fixed to the rigid frame 13.

For example, the frame comprises a first tube 2 which surrounds one of the two sides of the user 4.

According to an embodiment, the rigid frame 13 can comprise a back support 3 attached to the first tube 2, the back support 3.

The support 1 has a force of gravity F1. The force of gravity F1 is applied, for example, on the rigid frame 13 by way of an application point P1.

As can be seen, in particular in FIG. 7, the force of gravity is applied by the support on the rigid frame 13 by way of several points, each with a certain force. However, the force applied on each of the several points can be grouped together into one single force, called force of gravity F1 applied on one single point P1, called application point.

Under the effect of the force of gravity F1, the hands-free system 10, when it is arranged around the user 4, tilts.

More specifically, the hands-free system 10 is configured such that when it is arranged around the user 4, it tilts under a force F1 of gravity of the support 1 frontwards of the user 4 about a rotation axis I.

To obtain this, it is provided that the application point P1 being located in front of the user 4 such that the rotation axis I is arranged between the user 4 and the application point P1.

In addition, it is provided that the hands-free system 10 comprises three support points P2, P3, P4 on the user 4 to retain the tilting thereof. Thus, the hands-free system 10 is held on the user 4. In other words, the hands-free system 10 is thus mounted on the user 4 as can be seen in FIG. 8.

The support point P2 will act on a point P2 of the user that can be seen in FIG. 5. For example, the rigid frame 13 comprises the back point P2. The point P2 is located on the spine of the user 4, for example between the two shoulder blades. In other words, the support point P2 is a back point P2 acting on the spine of the user 4.

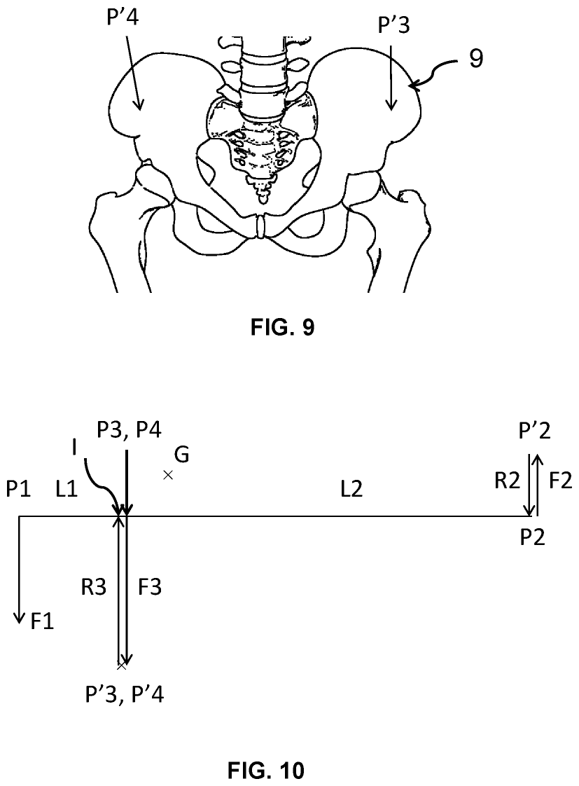

The support points P3 and P4 will act respectively on the points P′3 and P′4 of the user. As can be seen in FIG. 9, the points P′3 and P′4 are located on the iliac bones of the user 4. More specifically, the point P′3 is located on the left iliac bone 9 of the user and the point P′4 is located on the right iliac bone 9 of the user 4. In other words, the support points P3 and P4 are front points acting on the iliac bones 9 of the user 4.

As can be seen, in particular, in FIGS. 3 to 6, the first tube surrounds one of the two sides of the user by going from the support 1 to the back point P2. In addition, the first tube 2 has the shape of a curve according to which the back point P2 is located at a level above the support 1.

In the case of the embodiment example according to which the frame comprises a back support 3, the back support can comprise the back point P2.

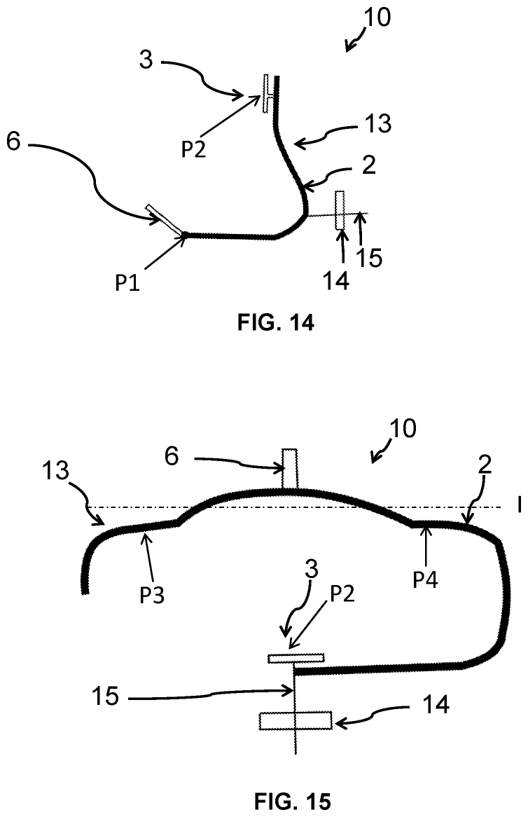

For example, the back support is made of wood. However, it can be provided that the back support 3 comprises metal in order to make it possible to counterweight, in order to reduce the force exerted by the back point on the spine of the user. Other embodiments of the counterweight are explained in reference to FIGS. 14 to 17.

According to this embodiment, the support comprises a tablet 1 fixed on the rigid frame 13. This tablet 1 and the fixing thereof can be seen, in particular in FIG. 7. For example, the tablet comprises the two front points P3, P4.

As can be seen in FIG. 8, the user 4 comprises a centre of gravity G. The front points P3 and P4 are close to the centre of gravity, such that the action thereof is made on the points close to the centre of gravity of the user to limit the imbalance thereof.

FIG. 10 explains the functioning of the hands-free system schematically. In FIG. 10, the following can be seen:
the axis I represented in the form of a point, the plane of FIG. 10 being perpendicular to the axis I. For example, it can be provided that the axis I is combined with the front points P3 and P4.
the point P1 by which the force of gravity F1 of the support 1 is applied on the frame 13;
the point P2 by which the force F2 of the frame 13 is applied on the point P′2 of the user;
the points P3 and P4 by which the force F3 is applied on the points P′3 and P′4 of the user.

According to the first embodiment, the points P3 and P4 are located on the support, such that the force F3 is applied by the support on the points P′3 and P′4 of the user.

As can be seen in FIG. 10, the tilting of the hands-free system about the axis I, generates, from the force F1, the forces F3 and F2. The force F3 applied on the user generates a reaction force R3 on the points P3 and P4. Likewise, the force F2 applied on the user generates a reaction force on the point P2. These are these two pairs of forces R3, F3 and R2, F2 which make it possible to hold the hands-free system on the user, such that the hands-free system is mounted on the user.

In addition, even when the support is filled with a significant weight, the hands-free system remains mounted on the user, since the pairs of forces R3, F3 and R2, F2 consequently increase.

In the plane of FIG. 10, i.e. the plane perpendicular to the axis I, the distance between the axis I and the point P1 is L1 while the distance between the axis I and the point P2 is L2.

By using Newton's fundamental principle of dynamics on the lever that forms the hands-free system, this makes F1/R2=L2/L1, i.e. given R2=F2, F1/F2=L2/L1 or also F2/F1=L1/L2.

Thus, F2 can be reduced with respect to F1 by selecting L1 less than L2. For example, the ratio L2/L1 being between 1.2 and 5 is selected, wherein L1 is the distance between the rotation axis I and the application point P1 and L2 is the distance between the rotation axis I and the back point P2. This makes it possible to reduce the force F2 exerted on the spine.

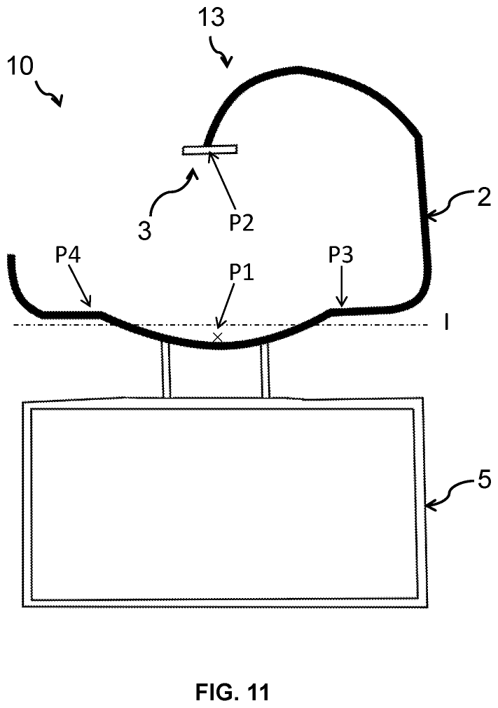

FIG. 11 represents the hands-free system according to a second embodiment of the invention. The second embodiment is distinguished from the first embodiment, in that the support comprises a tray 5. In addition, according to the second embodiment, it is the rigid frame 2 comprising the two front points P3, P4 such that the force F3 is applied by the rigid frame on the points P′3 and P′4 of the user.

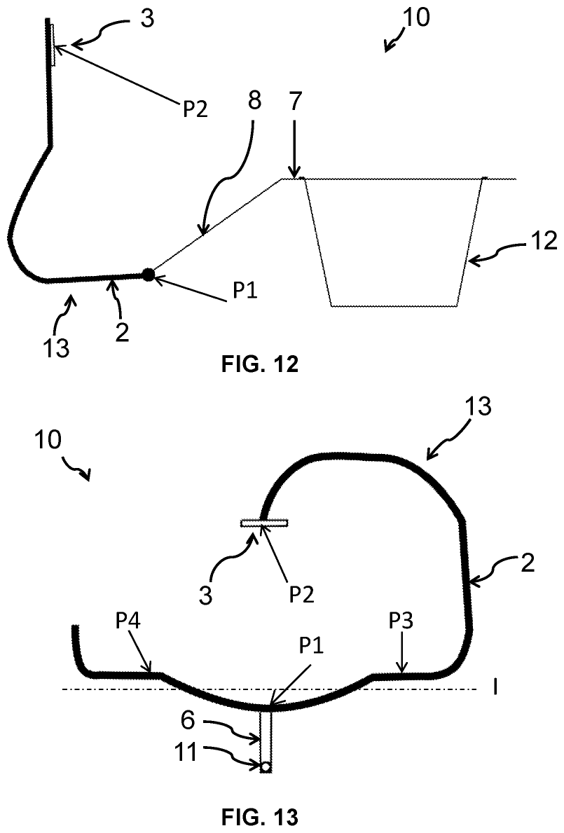

FIG. 12 represents the hands-free system according to a third embodiment of the invention. The third embodiment is distinguished from the second embodiment, in that the support comprises a rod 8 and an annular frame 7 to receive a bucket 12.

It can be provided that with the rod 8 being fixed on the rigid frame 13, it is configured to extend along an oblique direction upwards with respect to the horizontal when the hands-free system 10 is mounted on the user 4. This makes it possible to clear the legs of the user.

FIG. 13 represents the hands-free system according to a fourth embodiment of the invention. The fourth embodiment is distinguished from the third embodiment, in that the support comprises a rod 6 and 15, a container 11 to receive a longitudinal element, the rod 6 being fixed on the rigid frame 13.

For example, the longitudinal element is the mast of a flag, a fishing rod or a pole capable of being connected to a device capable of taking photos or videos.

FIGS. 14 and 15 represent the hands-free system according to a first variant of a fifth embodiment of the invention. This first variant is distinguished from the fourth embodiment, in that the hands-free system comprises a sliding rod 15 and a counterweight 14 mounted sliding on said sliding rod 15, the counterweight 14 being placed at the back beyond the rigid frame 13. The sliding rod is, for example, fixed on the first tube 2.

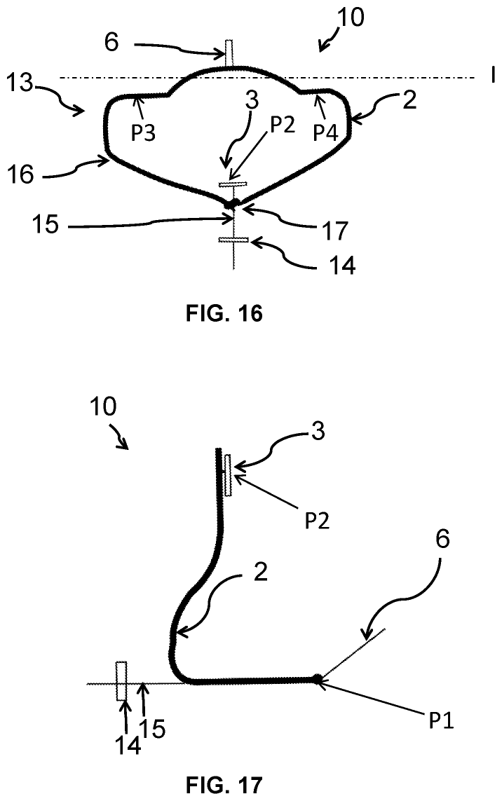

FIGS. 16 and 17 represent the hands-free system according to a second variant of the fifth embodiment of the invention. The second variant is distinguished from the first variant, in that the rigid 13 frame 30 comprises a second tube 16 surrounding the other side of the user, the sliding rod 15 being fixed to the second tube 16 and in that the second tube 16 is fixed to the first tube 2.

Thus, the structure of the rigid frame can be reinforced. It is useful in particular to carry very heavy loads.

According to the fifth embodiment, a counterweight is thus obtained, which limits the forces applied by way of the back point. In particular, in the case where heavy loads are deposited on the support.

By making the counterweight slide, the force exerted by the counterweight can be adjusted.

Advantageously, the sliding tube is added in the bottom portion in order to conserve, at much as possible, stability of the assembly.

The arrangement of the different elements and/or means and/or steps of the invention, in the embodiments described above, must not be understood as requiring such an arrangement in all the implementations. In any case, it will be understood that various modifications can be applied to these elements and/or means and/or steps, without moving away from the sense and the scope of the invention.

1-12. (canceled)

13. A hands-free system for a user comprising a rigid frame and a support fixed to the rigid frame, wherein:
the hands-free system is configured such that when it is arranged around the user, the hands-free system tilts under the effect of a force of gravity of the support frontwards of the user about a rotation axis,
the hands-free system further comprises, when in use, three support points on the user to retain the tilting thereof such that the hands-free system is mounted on the user, two of said three points called front points acting when in use, on the iliac bones of the user and the third point called back point acting when in use, between the two shoulder blades of the user on their spine,
and the rigid frame comprises the back point and comprises a first tube which surrounds when in use, one of the two sides of the user by going from the support to the back point, the first tube having the shape of a curve according to which the back point is located at a level above the support.

14. The hands-free system according to claim 13, wherein the rigid frame comprises a back support attached to the first tube, the back support comprising the back point.

15. The hands-free system according to claim 14, wherein the back support comprises metal.

16. The hands-free system according to claim 13, further comprising a sliding rod and a counterweight mounted sliding on said sliding rod, the counterweight being placed at the back beyond the rigid frame.

17. The hands-free system according to claim 16, wherein the rigid frame comprises a second tube surrounding when in use, the other side of the user, the sliding rod being fixed to the second tube and in that the second tube is fixed to the first tube.

18. The hands-free system according to claim 13, wherein, when it is being used, the force of gravity is applied on the rigid frame by way of an application point, the application point being located in front of the user, such that the rotation axis is arranged between the user and the application point.

19. The hands-free system according to claim 18, wherein a ratio L2/L1 is between 1.2 and 5, wherein L1 is the distance between the rotation axis and the application point and L2 is the distance between the rotation axis and the back point.

20. The hands-free system according claim 13, wherein the support comprises a tablet fixed on the rigid frame, the tablet comprising the two front points.

21. The hands-free system according claim 13, wherein the rigid frame comprises the two front points.

22. The hands-free system according to claim 21, wherein the support comprises a rod and an annular frame to receive a bucket, the rod being fixed on the rigid frame and in that the rod is configured to extend along an oblique direction upwards with respect to the horizontal when the hands-free system is mounted on the user.

23. The hands-free system according to claim 21, wherein the support comprises a rod and a container to receive a longitudinal element, the rod being fixed on the rigid frame.

24. The hands-free system according to claim 21, wherein the support comprises a tray.
